(19) United States
(12) Patent Application Publication
(10) Pub. No.: US 2020/0318773 A1
(43) Pub. Date: Oct. 8, 2020

(54) PIPE REPAIR COMPOSITION AND METHOD

(71) Applicant: Thomas James McGrath, Wakefield (GB)

(72) Inventor: Thomas James MCGRATH, Wakefield (GB)

(21) Appl. No.: 16/303,468

(22) PCT Filed: May 19, 2017
(86) PCT No.: PCT/GB2017/051413

§ 371 Date: Nov. 20, 2018

(51) Int. Cl. F16L 55/165; F16L 55/163

(52) U.S. Cl. CPC F16L 55/1656; F16L 55/18; F16L 55/163

(57) ABSTRACT

A method of repairing a pipe and/or a drain. The method involves covering a damaged section (103) of pipe (100) with a binder material (110) and a conductive/dissipative material (120). The conductive/dissipative material (120) is arranged in contact with, suitably within, the binder material (110) and functions to reduce static electrical charge build-up across the binder material, compared to the static charge build-up that may otherwise occur in a comparable section of binder material not having the conductive/dissipative material. The method may reduce the risk of a spark produced by a static electrical discharge across the binder material causing a flammable liquid within the pipe to ignite. The method may therefore provide a safer pipe repair, particularly wherein the pipe is normally used for transporting flammable liquids. A kit, composition, pipe and uses of a kit or composition to repair a pipe are also provided.

### FIELD

The present invention relates to a method, kit or composition for repairing a pipe. In particular the invention relates to a method, kit or composition for repairing a pipe for transferring potentially flammable liquids. The present invention also relates to the use of such a kit or composition to repair a pipe and a pipe repaired by said method, kit or composition.

### BACKGROUND

Pipes for transferring liquid, for example drain pipes for removing liquid effluent, often become damaged through mechanical stress, impact or corrosion and therefore require repair. Such repairs are often carried out using a polymer resin which is applied to the inside surface of the pipe at the site of the pipe to be repaired and left to cure (or set), leaving a solid covering over the site of the damage which is sufficiently resistant to the liquid which the pipe is intended to convey. Such repairs are usually carried out by applying the polymer resin to a cylindrical section of the internal surface of the pipe which includes and covers the site of the pipe to be repaired, and therefore covers a complete circumference of the inside of the pipe along a certain length of the pipe, whether or not the damage is present on the whole circumference of the pipe. Repairing pipes in this way is found to be efficient in terms of repair time and reducing the risk that part of the damage is left uncovered by the polymer resin and therefore unrepaired. Such a repair covering a cylindrical section may be applied by a technician from a location distant from the site of the pipe to be repaired, for example from an inspection hatch, using appropriate equipment.

Repairing damaged pipes in this manner is often more cost effective than replacing the damaged pipes due to the repair process being less disruptive (compared to excavating a buried pipe and replacing a section of it) and requiring a shorter pipe downtime.

### SUMMARY OF THE INVENTION

If an earthed conductive/dissipative pipe, for example a pipe used to transfer potentially flammable liquids, is repaired using a common polymer resin, the repaired part of the pipe may become electrically insulating, especially if the pipe repair is carried out on a cylindrical section of the internal surface of the pipe. Such an electrically insulating part or section of the pipe may then allow static electrical charge to accumulate in the pipe at the site of the repair, for example either side of a repaired cylindrical section of the pipe. This accumulated static electrical charge may then produce a spark due to static electrical discharge which could cause a flammable liquid in the pipe to ignite. Such an ignition could cause serious damage the pipe and associated plant equipment, cause injury to plant operators and cause environmental pollution and damage through leakage of the liquid from the pipe.

It may be one aim of the present invention, amongst others, to provide a method, kit, composition, pipe or use that addresses at least one disadvantage of the prior art, whether identified here or elsewhere, or to provide an alternative to existing methods, kits, compositions, pipes or uses. For instance it may be an aim of the invention to provide a method of repairing a pipe which provides a repaired part of said pipe with a reduced potential for static charge accumulation and therefore a reduced risk of causing an ignition of a flammable liquid in the pipe.

According to aspects of the present invention, there is provided a method, kit, composition, pipe and use as set forth in the appended claims. Other features of the invention will be apparent from the dependent claims, and the description which follows.

According to a first aspect of the present invention, there is provided a method of repairing a pipe, the method comprising applying, to an internal surface of the pipe at a location of the pipe to be repaired, a binder material and a conductive/dissipative material for reducing static electrical charge build-up across the binder material.

The conductive/dissipative material may be additionally and/or alternatively defined as an at least partially conductive material and may include for example an anti-static, dissipative or conductive material. An insulating material would not reduce static charge build-up across the binder material as electrical charge would not pass along such a material.

The conductive/dissipative material provides sufficient conductivity to increase the conductivity of the binder material, suitably to increase the conductivity of the binder material to at least the conductivity of the pipe where the binder material is not located (i.e. the conductivity of the pipe before the damage and repair).

By across the binder material we mean across the length and/or width of the whole of at least a part of the binder material at the location of the pipe to be repaired.

The inventors have found that carrying out the method of this first aspect provides a repaired pipe which has sufficient conductivity in the repaired part to reduce, suitably prevent, static charge build-up across the repaired part of the pipe and therefore reduce the risk of a spark produced by a static electrical discharge across the binder material causing a flammable liquid within the pipe to ignite. The method of this first aspect may therefore provide a safer pipe repair, particularly wherein the pipe is normally used for transporting flammable liquids, and may therefore protect the pipework, associated plant and pipe/plant operators from damage or injury.

The method of this first aspect may allow the use of a highly chemically resistant and/or cost effective binder material, for example a polysilicate resin or an epoxy resin, to repair the pipe without increasing the risk of static electrical charge build-up on or across the binder material at the location of the pipe to be repaired.

The method of this first aspect may provide a more cost effective and/or chemically resistant repair than a similar method employing an electrically conductive binder material.

Suitably the method provides a pipe comprising a repaired section. Suitably the method provides a pipe comprising a repaired section which is dissipative or conductive. Suitably the method provides a pipe comprising a repaired section which is dissipative.

A material which has surface resistivity less than 10⁵ Ω/sq may be classified as a conductive material. Conductive materials have a relatively low electrical resistance and electrons flow easily across the surface or through the bulk of these materials. In such materials charges tend to go to ground or to another conductive object that the material contacts or comes close to.

A pipe which has an electrical resistance per length of less than 10³ Ω/m may be considered to be conductive.

A material which has an electrical resistivity of from 10⁵ to 10¹² Ω/sq may be classified as a dissipative material. In dissipative materials, charges flow to ground more slowly and in a more controlled manner than with conductive materials.

A pipe which has an electrical resistance per length of from 10³ to 10⁶ Ω/m may be considered to be dissipative.

A material which has an electrical resistivity of >10¹² Ω/sq may be classified as an insulative material. Insulative materials prevent or limit the flow of electrons across their surface or through their volume. Insulative materials have a relatively high electrical resistivity and are difficult to ground. Static charges remain in place on these materials for a relatively long time.

A pipe which has an electrical resistance per length of greater than 10⁶ Ω/m may be considered to be insulative.

Suitably the conductive/dissipative material may be additionally or alternatively defined as a material having an electrical resistivity of less than 10¹² Ω/sq.

Suitably the pipe on which the method of this first aspect is carried out is formed from a conductive or a dissipative material. Suitably the pipe on which the method of this first aspect is carried out is conductive or dissipative. For example the method may be carried out to repair a pipe formed from a conductive/dissipative clay, suitably a vitrified clay, for example Thermachem pipes supplied by Naylor Drainage Ltd.

Suitably the method provides a pipe comprising a repaired section which has an electrical resistivity of less than 10¹²Ω, suitably less than 10¹¹Ω, suitably less than 10¹⁰Ω. Suitably the method provides a pipe comprising a repaired section which has a surface electrical resistivity of less than 10¹² Ω/sq, suitably less than 10¹¹ Ω/sq, suitably less than 10¹⁰ Ω/sq.

Suitably the method provides a pipe comprising a repaired section which has an electrical resistivity of between 10⁵ and 10¹²Ω, suitably between 10⁶ and 10¹¹Ω, suitably between 10⁷ and 10¹⁰Ω. Suitably the method provides a pipe comprising a repaired section which has a surface electrical resistivity of between 10⁵ and 10¹² Ω/sq, suitably between 10⁶ and 10¹¹ Ω/sq, suitably between 10⁷ and 10¹⁰ Ω/sq.

Suitably the method provides a pipe comprising a repaired section which has an electrical resistance per length of from less than 10⁶ Ω/m, suitably less than 10⁵ Ω/m, for example less than 10⁴ Ω/m, suitably less than 10³ Ω/m, suitably across the binder material.

Suitably the method provides a pipe comprising a repaired section which is chemically resistant across the binder material and therefore provides the pipe with a chemically resistant repaired section.

Suitably, after the method of this first aspect is carried out, the pipe is repaired and remains conductive or dissipative.

The pipe has an internal surface which surrounds an internal space of the pipe, the internal space being the space through which liquid flows in use. Suitably the binder material has an inside surface which faces into the internal space of the pipe, after it has been applied to the pipe at the location of the pipe to be repaired.

The conductive/dissipative material reduces static charge build-up across the binder material when suitably arranged at the location of the pipe to be repaired, for example when the conductive/dissipative material is arranged at least partially in contact with the binder material and at least partially exposed to the internal space of the pipe.

The conductive/dissipative material may be arranged in contact with the binder material on the inside surface of the binder material.

Suitably the conductive/dissipative material is arranged partially within the binder material and partially outside the binder material so that the conductive/dissipative material provides a sufficient conductive pathway for static charge which may build up on the inside surface of the binder material, for example due to the flow of liquids over the binder material. For example, the conductive/dissipative material may be partially embedded in the binder material.

In some embodiments, the conductive/dissipative material may be fully embedded within the binder material.

Suitably the pipe is a drain pipe, suitably for conveying liquids, suitably flammable liquids, for example hydrocarbon solvents which may be flammable or comprise flammable products, by-products or residues from a chemical production process.

The binder material is suitably a polymeric material. Suitably the binder material is a polymer resin, suitably a polysilicate resin or an epoxy resin. The binder material may be chemically resistant but electrically insulating. Suitably the binder material has a flowable state which facilitates application to the pipe at the location of the pipe to be repaired and a cured (or set) state which is achieved a certain amount of time after application to the pipe. The binder material may be produced by mixing two or more components, for example liquid components, which starts a chemical reaction leading to the curing of the binder material to form a solid mass of binder material, for example after application on the pipe at the location to be repaired. Suitable binder materials, liquid binder material components and ways of applying such binder materials to surfaces are known in the art. For example the binder material may be formed by mixing epoxy resin component parts A and B.

The conductive/dissipative material may be in the form of conductive/dissipative particles or may be in the form of at least one elongate element.

Suitably the conductive/dissipative material is formed from an antistatic, dissipative or conductive material.

A material which has an electrical resistivity of less than 10⁵ Ω/m may be classified as a conductive material.

A material which has an electrical resistivity of from 10⁵ to 10⁹ Ω/m may be classified as a dissipative material.

A material which has an electrical resistivity of from 10⁹ to 10¹² Ω/m may be classified as an anti-static material.

A material which has an electrical resistivity of >10¹³ Ω/m may be classified as an insulating material.

Suitably the conductive/dissipative is formed from a material with an electrical resistivity of less than 1×10⁻³ Ωm, suitably less than 1×10⁻⁶ Ωm, for example less than 1×10⁻⁷ Ωm, suitably less than 2×10⁻⁸ Ωm.

The conductive/dissipative material may comprise a metal, suitably a metal selected from copper, gold, aluminium, iron or steel. Suitably the conductive/dissipative material comprises copper.

The conductive/dissipative material may consist essentially of a metal, suitably a metal selected from copper, gold, aluminium, iron or steel. Suitably the conductive/dissipative material consists essentially of copper.

The conductive/dissipative material may be formed from a metal, suitably a metal selected from copper, gold, aluminium, iron or steel. Suitably the conductive/dissipative material is formed from copper.

Suitably the conductive/dissipative material is formed from a conductive material.

The inventors have found that forming the conductive/dissipative material from a conductive material, for example copper, provides a highly effective reduction in static electrical charge build-up on or across the repaired section of the pipe. The conductive/dissipative material being formed from a conductive material facilitates the formation of a repaired section of the pipe with an electrical resistivity which may be classified as dissipative and/or conductive, suitably dissipative.

The binder material and the conductive/dissipative material may be applied to the internal surface of the pipe sequentially. For example, the binder material may be applied to the internal surface of the pipe at the location of the pipe to be repaired first followed by application of the conductive/dissipative material to the binder material at the location of the pipe to be repaired. Alternatively, the conductive/dissipative material may be applied to the internal surface of the pipe at the location of the pipe to be repaired first followed by application of the binder material to the conductive/dissipative material at the location of the pipe to be repaired.

Suitably the binder material and the conductive/dissipative material are applied to the internal surface of the pipe together.

For example the binder material and the conductive/dissipative material may be applied to the internal surface of the pipe at the location of the pipe to be repaired substantially at the same time.

Alternatively, the binder material and the conductive/dissipative material may be combined first and then applied to the pipe at the location of the pipe to be repaired together.

Combining the binder material and the conductive/dissipative material before application to the pipe at the location of the pipe to be repaired has the advantage that only a single application process is carried out on the pipe to complete the repair. Such a method also has the advantage that the conductive/dissipative material can be partially or completely immersed in the binder material to the extent required to provide either partial or complete embedding of the conductive/dissipative material in the binder material in the repaired section.

Suitably the method comprises the steps of:

a) applying the binder material to the internal surface of the pipe at a location of the pipe to be repaired; and

b) applying the conductive/dissipative material to the internal surface of the pipe at the location of the pipe to be repaired, in contact with the binder material and substantially traversing the binder material.

Suitably the steps of the method are carried out in the order step a) followed by step b).

Suitably the conductive/dissipative material traverses the binder material in a direction approximately aligned with a flow direction of the pipe, in other words in the direction a liquid would flow through the pipe in use.

A liquid flowing through the repaired pipe may cause static electrical charge build-up between two points on the binder material as the liquid flows across the binder material. Therefore the conductive/dissipative material being arranged to traverse the binder material, suitably in a flow direction of the pipe, has the advantage that the static electrical charge which may build-up across the binder material can be effectively discharged by the conductive/dissipative material.

The conductive/dissipative material suitably traverses the binder material across a majority of the binder material and a sufficient portion of the binder material to prevent a significant build-up of static electrical charge. In order to achieve this the conductive/dissipative material may not have to traverse the entire length and/or width of binder material.

Suitably the pipe is a cylindrical tube.

The pipe may be any length, suitably at least 3 m in length, for example at least 5 m in length or at least 10 m in length.

The pipe may be buried in the ground and may therefore not be directly accessible for removal and replacement without excavation. Such a pipe may be repaired in the method of this first aspect from an inspection hatch.

Suitably the binder material covers a cylindrical section of the pipe.

By cylindrical section we mean the repair is carried out completely around the circumference of the internal surface of the pipe along a certain length of the pipe.

Suitably the binder material covers a length of the pipe of at least 10 cm, for example at least 30 cm, suitably at least 50 cm or at least 100 cm.

Suitably the binder material covers a length of the pipe up to 20 m, for example up to 10 m, suitably up to 5 m.

In some embodiments, the conductive/dissipative material is in the form of conductive/dissipative particles. Therefore this first aspect may provide a method of repairing a pipe, the method comprising applying, to an internal surface of the pipe at a location of the pipe to be repaired, a binder material and conductive/dissipative particles for reducing static electrical charge build-up across the binder material.

The conductive/dissipative particles may be in any suitable form for distribution/dispersion into a pipe repair, for example granules, needles and powders.

The conductive/dissipative particles may be in the form of a powder. The conductive/dissipative material may be a conductive/dissipative powder, suitably a conductive powder. By conductive powder we mean a powder of a conductive material. The conductive powder may not be conductive in itself but may be formed from a material which is conductive when provided in another form such as a wire or sheet.

The conductive/dissipative particles may comprise a metal, suitably a metal selected from copper, gold, aluminium, iron or steel. Suitably the conductive/dissipative particles comprise copper.

The conductive/dissipative particles may consist essentially of a metal, suitably a metal selected from copper, gold, aluminium, iron or steel. Suitably the conductive/dissipative particles consist essentially of copper.

The conductive/dissipative particles may be formed from a metal, suitably a metal selected from copper, gold, aluminium, iron or steel. Suitably the conductive/dissipative particles are formed from copper.

Suitably the conductive/dissipative particles are copper powder.

Suitably the conductive/dissipative particles are copper needles.

Suitably the conductive/dissipative particles are combined with the binder material before being applied to the internal surface of the pipe at a location of the pipe to be repaired. Suitably the conductive/dissipative particles are substantially homogeneously mixed with the binder material before being applied to the internal surface of the pipe at a location of the pipe to be repaired.

The method may involve applying to the internal surface of the pipe at the location of the pipe to be repaired, a mixture of the binder material and the conductive/dissipative particles for reducing static electrical charge build-up across the binder material.

The method may involve forming on the internal surface of the pipe at the location of the pipe to be repaired, a mixture of the binder material and the conductive/dissipative particles for reducing static electrical charge build-up across the binder material.

Suitably the conductive/dissipative particles are dispersed within the binder material in a concentration sufficient to allow static charge build-up on the inside surface of the binder material to be conducted/dissipated away by the conductive/dissipative particles. Suitably the conductive/dissipative particles allow static charge build-up on the inside surface of the binder material to be conducted/dissipated away despite the conductive/dissipative particles not being in physical contact with each other.

The mixture of the binder material and the conductive/dissipative particles may comprise at least 10 wt % of the conductive/dissipative particles, suitably at least 20 wt %, suitably at least 30 wt %.

The mixture of the binder material and the conductive/dissipative particles may comprise up to 80 wt % of the conductive/dissipative particles, suitably up to 70 wt %, suitably up to 60 wt %.

The mixture of the binder material and the conductive/dissipative particles may comprise from 10 to 80 wt % of the conductive/dissipative particles, suitably from 20 to 70 wt %, suitably from 30 to 70 wt %.

Suitably, in embodiments wherein the conductive/dissipative material is in the form of conductive/dissipative particles, the conductive/dissipative particles may be combined with the binder material and then applied to a pipe liner. Suitably the pipe liner is flexible, for example a fibreglass pipe liner. Suitable flexible and/or fabric-like pipe liners are known in the art. Suitably the pipe liner comprising the combination of the binder material and the conductive/dissipative particles is then applied to the internal surface of the pipe at a location of the pipe to be repaired.

Alternatively, the conductive/dissipative particles may be incorporated into a pipe liner prior to the binder material being applied to the pipe liner.

The conductive/dissipative particles may be incorporated into a pipe liner either during manufacture of the pipe liner or after manufacture of pipe liner and prior to the use of the pipe liner in a method of this first aspect.

The inventors have found that using conductive/dissipative particles as the conductive/dissipative material may provide a simple method of pipe repair whereby the conductive/dissipative particles can be easily mixed with the binder material before application to the pipe to be repaired, in order to provide the improvements in safety of the repaired section discussed above.

In some embodiments, the conductive/dissipative material is in the form of at least one elongate element. Therefore this first aspect may provide a method of repairing a pipe, the method comprising applying to an internal surface of the pipe at a location of the pipe to be repaired, a binder material and at least one elongate element for reducing static electrical charge build-up across the binder material.

Suitably the elongate element traverses the binder material in a direction approximately aligned with a flow direction of the pipe, in other words in the direction a liquid would flow through the pipe in use.

A liquid flowing through the repaired pipe may cause static electrical charge build-up between two points on the binder material as the liquid flows across the binder material. Therefore the at least one elongate element being arranged to traverse the binder material, suitably in a flow direction of the pipe, has the advantage that the static electrical charge which may build-up across the binder material can be effectively discharged by the at least one elongate element.

The elongate element suitably traverses the binder material across a majority of the binder material and a sufficient portion of the binder material to prevent a significant build-up of static electrical charge. In order to achieve this, the elongate element may not have to traverse the entire length and/or width of binder material.

The elongate element may traverse the entire length and/or width of binder material, for example by the elongate element being longer than the length of the binder material and/or by coating or immersing the elongate element in the binder material before application to the pipe only to the extent that a first end and a second end of the elongate element are left uncoated or uncovered by the binder material.

The at least one elongate element reduces static charge build-up across the binder material when suitably arranged at the location of the pipe to be repaired, for example when the elongate element is arranged at least partially in contact with the binder material and at least partially exposed to the internal space of the pipe.

The elongate element may be arranged in contact with the binder material on the inside surface of the binder material.

Suitably the elongate element is arranged partially within the binder material and partially outside the binder material so that the elongate element provides a sufficient conductive pathway for static charge which may build up on the inside surface of the binder material, for example due to the flow of liquids over the binder material. For example, the elongate element may be partially embedded in the binder material so that several parts or sections of the elongate element are exposed to the internal space of the pipe and the exposed parts or sections of the elongate material may provide the conductive pathway for dissipating static charge build-up on or across the binder material.

The elongate element may be fully embedded within the binder material, suitably with a layer of binder material between the inside surface of the binder material and the elongate element which is sufficiently thin to allow static charge build-up on the inside surface of the binder material pass through to then be conducted/dissipated away by the elongate element.

The elongate element may be arranged in a pipe liner, for example a fibreglass pipe liner.

The inventors have found that using at least one elongate element as the conductive/dissipative material provides a repaired pipe which has sufficient conductivity in the repaired part to reduce, suitably prevent, static charge build-up across the repaired part of the pipe in order to provide the improvements in safety of the repaired section discussed above. The at least elongate element may provide a robust and continuous path of conductive/dissipative material which can reliably and effectively reduce static electrical charge build-up across the binder material. Such a continuous path of conductive/dissipative material may enable a less conductive and possibly cheaper conductive/dissipative material to be used in the method than if the conductive/dissipative material provided a discontinuous path for the reduction of static electrical charge build-up across the binder material.

In some embodiments, the conductive/dissipative material is in the form of a plurality of elongate elements for reducing static electrical charge build-up across the binder material.

Suitably a plurality of elongate elements for reducing static electrical charge build-up across the binder material are applied to the internal surface of the pipe.

The plurality of elongate elements may be provided as wires, for example metal wires, suitably copper wires.

The plurality of elongate elements may be regularly spaced around the internal surface of the pipe.

The plurality of elongate elements may traverse the binder material in different directions which may provide conductive pathways in different directions for dissipating static electrical charge build-up.

The plurality of elongate elements may be separated.

The plurality of elongate elements may be interlinked which may improve the efficiency of static electrical charge dissipation.

The plurality of elongate elements may be provided as a mesh, for example a mesh having a plurality of elongate elements arranged side by side in a first direction and interlinked with a plurality of elongate elements arranged side by side in a second direction, the second direction being approximately perpendicular to the first direction. The plurality of elongate elements may be provided as a metal wire mesh. The plurality of elongate elements may be provided as a copper wire mesh.

The plurality of elongate elements may be provided as a matting, for example a matting of interlinked elongate members.

The plurality of elongate elements may be arranged on or in a pipe liner, for example a fibreglass pipe liner. Suitably the plurality of elongate elements is provided as a mesh or matting and is arranged inside a pipe liner. Suitably the mesh or matting is arranged between and affixed to two layers of pipe liner to form a pipe liner comprising a plurality of elongate elements. Such a pipe liner may be described as having a “sandwich” structure, for example, having a layer of elongate elements (for reducing static electrical charge build-up across the binder material) between two layers of fibreglass pipe liner.

The plurality of elongate elements may be arranged on the inside surface of a pipe liner.

The plurality of elongate elements may be arranged in a pipe liner, for example a fibreglass pipe liner, such that the plurality of elongate elements are exposed on a surface of the pipe liner which will be exposed to the inside of the pipe to be repaired. For example the plurality of elongate elements may be needled/interwoven into a pipe liner. Suitably the plurality of elongate elements are arranged in a tubular pipe liner, for example a fibreglass pipe liner, such that the plurality of elongate elements are exposed on the inside surface of the tubular pipe liner which will be exposed to the inside of the pipe to be repaired.

The inventors have found that a plurality of elongate elements may be more effective in reducing static electrical charge build-up across the binder material than a single elongate element by providing more conductive/dissipative pathways for dissipating static electrical charge build-up, particularly if the plurality of elongate elements are regularly spaced around the internal surface of the pipe, particularly if the plurality of elongate elements are interlinked and especially if the plurality of elongate elements are provided as a mesh or matting.

Suitably the elongate elements are arranged on the internal surface of the pipe in a tubular shape complimentary to the internal surface of the pipe.

Suitably the elongate elements are arranged against and substantially flush with the internal surface of the pipe to maintain the size of the internal space of the pipe after the repair has been carried out, insofar as possible.

The elongate elements may be provided in a tubular shape complimentary to the internal surface of the pipe, for example as a tubular wire mesh.

Suitably the elongate elements are provided as a tubular mesh.

Alternatively the elongate elements may be provided as a sheet. Such a sheet may be formed into a tubular shape complimentary to the internal surface of the pipe before or during application to the internal surface of the pipe. For example the elongate elements may be provided as a wire mesh sheet.

The inventors have found that using a tubular shaped plurality of elongate elements, for example either as a tubular mesh or a mesh sheet, facilitates the application of the plurality of elongate elements to the internal surface of the pipe at the location of the pipe to be repaired and provides an effective means of reducing static electrical charge build-up across the binder material.

Suitably the elongate elements are provided by a copper wire mesh sheet or a tubular copper wire mesh.

Suitably, in embodiments wherein the at least one elongate element is a plurality of elongate elements which are provided as a mesh or matting, the method may involve the steps of:

i) combining the binder material and the mesh or matting;

ii) wrapping the combined binder material and mesh or matting around an expandable member;

iii) inserting the expandable member into the pipe so that the combined binder material and mesh or matting are adjacent to the location of the pipe to be repaired;

iv) expanding outwards the expandable member so that the combined binder material and mesh or matting contact the internal surface of the pipe at the location of the pipe to be repaired;

v) contracting inwards the expandable member and removing the expandable member from the pipe, leaving the combined binder material and the mesh or matting in place on the pipe at the location of the pipe to be repaired.

The binder material and the mesh or matting may be combined by pouring and/or spreading a liquid binder material onto the mesh or matting, for example after a liquid binder material has been prepared by mixing reactive components of the binder material, starting a chemical reaction which causes the binder material to cure after a certain period of time. Such binder materials would be known to the skilled person.

Suitable expandable members may include inflatable members, for example a hose or tube comprising a flexible balloon sealed over a part or end of the hose or tube which can expand outwards when compressed air is directed into the balloon through the hose or tube. Such expandable members would be known to the skilled person.

Step iii) involves inserting the expandable member into the pipe, for example through an inspection hatch. The expandable member is suitably an elongate expandable member, suitably with a circumference shorter than the circumference of the pipe. The expandable member may be attached to a rod to facilitate inserting the expandable member into the pipe to the required position and subsequently withdrawing the expandable member.

Step iv) involves expanding the expandable member so that the combined binder material and mesh or matting contact the internal surface of the pipe at the location of the pipe to be repaired; suitably by directing compressed air into the expandable member. Suitably the expandable member presses the combined binder material and mesh or matting against the internal surface of the pipe with sufficient force to form an initial bond between the binder material and the internal surface of the pipe.

Suitably after step iv) and before step v), the expandable member, binder material and mesh or matting are left in place at the location of pipe to be repaired, with the expandable member pressing the combined binder material and mesh or matting against the internal surface of the pipe, for a sufficient period of time, for example 30 minutes, for the binder material to cure and form a solid mass comprising the mesh or matting and covering the location of the pipe to be repaired.

Suitably step v) results in the expandable member releasing from the combined binder material and mesh or matting, leaving the combined binder material and mesh or matting in place on the internal surface of the pipe at the location of the pipe to be repaired, as a solid mass.

In alternative embodiments, the mesh or matting may be wrapped around the expandable member before being combined with the binder material.

Suitably the at least one elongate element comprises copper.

Suitably the at least one elongate element is formed from copper. Suitably the at least one elongate element consists essentially of copper.

Suitably, in embodiments wherein the conductive/dissipative material is in the form of conductive/dissipative particles, the method may involve the steps of:

1) combining the binder material with the conductive/dissipative particles;

2) combining the combination of the binder material and the conductive/dissipative particles with a pipe liner;

3) wrapping the pipe liner comprising the combination of the binder material and the conductive/dissipative particles around an expandable member;

4) inserting the expandable member into the pipe so that the pipe liner comprising the combination of the binder material and the conductive/dissipative particles is adjacent to the location of the pipe to be repaired;

5) expanding outwards the expandable member so that the pipe liner comprising the combination of the binder material and the conductive/dissipative particles contacts the internal surface of the pipe at the location of the pipe to be repaired;

6) contracting inwards the expandable member and removing the expandable member from the pipe, leaving the pipe liner comprising the combination of the binder material and the conductive/dissipative particles on the pipe at the location of the pipe to be repaired.

Suitably the pipe liner is a fibreglass pipe liner known in the art.

In some embodiments, the method may involve the steps of:

A) providing a tubular pipe liner comprising the conductive/dissipative material and applying the binder material to an outside surface of the tubular pipe liner;

B) turning the tubular pipe liner inside out so that binder material is on an inside surface of the tubular pipe liner;

C) arranging the tubular pipe liner adjacent to the location of the pipe to be repaired;

D) turning the tubular pipe liner inside out so that the surface of the tubular pipe liner comprising the binder material is progressively applied to the location of the pipe to be repaired.

Suitably the pipe liner is a fibreglass pipe liner known in the art.

This method may be particularly beneficial in providing a repair to a relatively long section of pipe.

In some embodiments, the conductive/dissipative material is provided by at least one elongate element and by conductive/dissipative particles. Therefore this first aspect may provide a method of repairing a pipe, the method comprising applying to an internal surface of the pipe at a location of the pipe to be repaired, a binder material, at least one elongate element for reducing static electrical charge build-up across the binder material and conductive/dissipative particles for reducing static electrical charge build-up across the binder material.

The conductive/dissipative particles and the at least one elongate element may be applied to the pipe at the location of the pipe to be repaired as described above for the embodiments using either the conductive/dissipative particles or the at least one elongate element.

The conductive/dissipative particles and the at least one elongate element may have any of the features described above in relation to the embodiments using either the conductive/dissipative particles or the at least one elongate element.

Suitably the conductive/dissipative particles applied to the internal surface of the pipe at the location of the pipe to be repaired are incorporated, during the method, into the binder material. For example the conductive/dissipative particles may be mixed with the binder material before the binder material is combined with the at least one elongate element.

According to a second aspect of the present invention, there is provided a kit for repairing a pipe, the kit comprising:

a binder material; and

a conductive/dissipative material.

The kit of this second aspect may be used in a method according to the first aspect.

The suitable features and advantages of the binder material of this second aspect are as described in relation to the first aspect.

The suitable features and advantages of the conductive/dissipative material of this second aspect are as described in relation to the conductive/dissipative material of the first aspect.

The kit of this second aspect may provide a convenient and effective pipe repair kit which may provide a pipe repair with a reduced potential for static electrical charge build-up and therefore a reduced risk of igniting a flammable liquid flowing through the pipe.

According to a third aspect of the present invention, there is provided a composition for repairing a pipe, the composition comprising:

a binder material; and

a conductive/dissipative material for reducing static charge build-up across the binder material.

The suitable features and advantages of the binder material of this third aspect are as described in relation to the first aspect.

The suitable features and advantages of the a conductive/dissipative material of this third aspect are as described in relation to the conductive/dissipative material of the first aspect.

According to a fourth aspect of the present invention, there is provided a pipe comprising at least one section comprising a binder material and a conductive/dissipative material for reducing static charge build-up across the binder material.

The suitable features of the pipe of this fourth aspect are as described in relation to the pipe of the first aspect.

The suitable features and advantages of the binder material of this fourth aspect are as described in relation to the first aspect.

The suitable features and advantages of the conductive/dissipative material of this fourth aspect are as described in relation to the conductive/dissipative material of the first aspect.

Suitably the pipe has an electrical resistance per length of less than 10⁶ Ωm, suitably less than 10⁵ Ωm, for example less than 10⁴ Ωm, suitably less than 10³ Ωm, along the at least one section comprising a binder material and the conductive/dissipative material.

Suitably the pipe is chemically resistant across the at least one section comprising a binder material and the conductive/dissipative material.

Suitably the pipe comprises damage which has been covered and repaired by the binder material and the conductive/dissipative material for reducing static charge build-up across the binder material. Suitably the at least one section comprising a binder material and a conductive/dissipative material for reducing static charge build-up across the binder material is a repaired section.

Suitably the pipe of this fourth aspect has been repaired by a method according to the first aspect.

According to a fifth aspect of the present invention, there is provided a use of conductive/dissipative material to repair a pipe to provide a repaired section of pipe, wherein the conductive/dissipative material reduces static electrical charge build-up in the repaired section of pipe.

The suitable features and advantages of the use of this fifth aspect are as described in relation to the method of the first aspect.

The suitable features and advantages of the conductive/dissipative material of this fifth aspect are as described in relation to the conductive/dissipative material of the first aspect.

According to a sixth aspect of the present invention, there is provided a use of a composition comprising a binder material and a conductive/dissipative material for reducing static charge build-up across the binder material, to repair a pipe.

The suitable features and advantages of the use of this sixth aspect are as described in relation to the method of the first aspect.

The suitable features and advantages of the binder material of this sixth aspect are as described in relation to the first aspect.

The suitable features and advantages of the conductive/dissipative material of this sixth aspect are as described in relation to the conductive/dissipative material of the first aspect.

### BRIEF DESCRIPTION OF THE DRAWINGS

For a better understanding of the invention, and to show how example embodiments may be carried into effect, reference will now be made to the accompanying drawing in which:

FIG. 1 is a perspective view of a section of a pipe (100) according to the fourth aspect of the present invention which has been repaired by a method of the first aspect of the present invention using a composition of the third aspect of the present invention.

### DETAILED DESCRIPTION OF THE EXAMPLE EMBODIMENTS

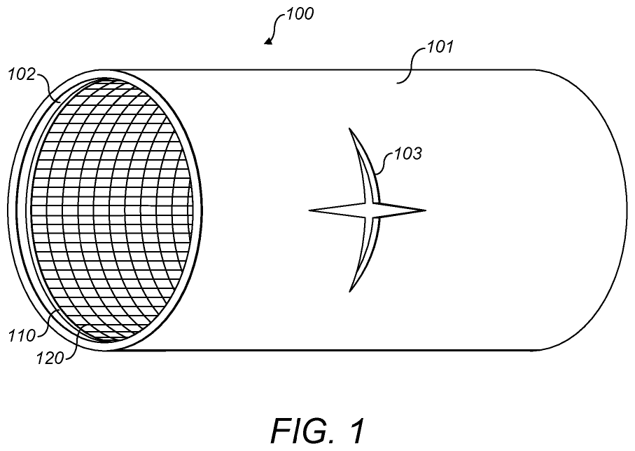

FIG. 1 shows a section of pipe (100) comprising an outer surface (101) and an inner surface (102). The pipe comprised damage in the form of crack (103) which formed an opening from the outer surface (101) to the inner surface (102) of the pipe (100). The damage was repaired by combining a binder material (110) with a copper mesh formed into a tube (120), applying the binder material (110) and the tube of copper mesh (120) to the inside surface of the pipe (102) and then allowing the binder material (110) to cure. Once curing was complete, the repaired pipe (100) was obtained having an inside surface covered with solidified binder material (110) partially impregnated with the tubular copper mesh (120).

### EXAMPLE SET 1

By way of example, a method of the first aspect was carried out on a test section of pipe to provide the test section of pipe with a binder material and a conductive/dissipative material for reducing static charge build-up across the binder material.

The test section of pipe was prepared by combining epoxy resin component parts A and B to produce a binder material, applying the binder material to a copper mesh (either fine or course), wrapping the combined binder material and copper mesh around an expandable member, inserting the expandable member into a section of Thermachem pipe supplied by Naylor Drainage Ltd. (a conductive/dissipative vitrified clay pipe), expanding outwards the expandable member with compressed air so that the combined binder material and copper mesh contacted the internal surface of the pipe, contracting inwards the expandable member by venting the compressed air and removing the expandable member from the pipe to leave the combined binder material and the mesh in place on the pipe.

The test section of pipe was analogous to the section of pipe (100) shown in FIG. 1 but was not damaged. The test section of pipe had an inside surface covered with solidified binder material (110) partially impregnated with the tubular copper mesh (120).

This method was used with a “coarse” copper mesh to provide test pipe 1a and also with a “fine” copper mesh to provide test pipe 1b.

The test section of pipe was tested for surface electrical resistivity according to the following procedure.

The units of surface electrical resistivity are Ω and Ω/sq. It describes the ability of a material to conduct electric charge across its surface and is the reciprocal of the surface conductivity.

### Method of Measurement

The surface resistivity, is calculated using the Ohms' Law formula

$$P s = ( \frac{V}{I} ) k$$

where:
Ps=Surface resistivity of material (in Ω/□)
V=Applied voltage
I=Measured Current (in Amperes)
K=Cell constant (length of measuring electrodes (100 mm)/distance between measuring electrodes (10 mm)=10

A measurement cell was used consisting of a current measuring electrode separated by polytetrafluoroethylene (PTFE) insulation from a parallel voltage application electrode. The measurement cell was then connected to an Electrometer which measured the resultant current across the material between the electrodes.

The parallel electrode was placed onto various locations of the test specimen or at least 10 mm away from the edges. The cell was energised at 10 V. If the calculated resistance was less than 1.0×10⁶Ω then this result was recorded and the procedure repeated at other areas on the specimen or on fresh material, if available.

If the calculated resistance was greater than 1.0×10⁶Ω but less than 1.0×10⁷Ω then the test procedure was repeated using 100 V. For measured resistances of between 1.0×10⁷Ω and 1.0×10⁹Ω, the test procedure was conducted at 500 V. With measured resistances above 1.0×10⁹Ω the test voltage was raised to 1000 V.

The calculated resistance (applied voltage/measured current) is then substituted into the above formula to calculate a surface resistivity value, the geometric average of all areas tested was given as the final value of resistivity.

Most materials adsorb atmospheric water to a lesser or greater extent, which for many materials has a dramatic effect on the surface resistivity. The test was therefore carried out at a relative humidity (RH 50±5%) and in dryer conditions (RH 25±2%). In both cases the sample is conditioned at the stated relative humidity for 24 hours prior to testing.

In the results shown in the Tables below, “E” is used to denote exponential therefore, for example, 1.8E+07 means 1.8×10⁷.

### Test Results for Example Set 1

TABLE 1
Test results with test pipe 1a “coarse” mesh
liner at 50% relative humidity (RH)
50% RH/21° C. - test pipe 1a “coarse” mesh liner

| | | | Calculated | Surface |
|---|---|---|---|---|
| | | Current | Resistance | Resistivity |
| Test | Voltage | (A) | (Ω) | (Ω/sq) |
| 1 | 1000 | 5.5E−04 | 1.8E+06 | 1.8E+07 |
| 2 | 1000 | 6.0E−04 | 1.7E+06 | 1.7E+07 |
| 3 | 1000 | 1.5E−07 | 6.7E+09 | 6.7E+10 |
| 4 | 1000 | 6.0E−07 | 1.7E+09 | 1.7E+10 |
| 5 | 1000 | 2.0E−07 | 5.0E+09 | 5.0E+10 |
| 6 | 1000 | 1.8E−07 | 5.6E+09 | 5.6E+10 |
| 7 | 1000 | 5.0E−07 | 2.0E+09 | 2.0E+10 |
| 8 | 1000 | 4.0E−04 | 2.5E+06 | 2.5E+07 |
| 9 | 1000 | 5.5E−04 | 1.8E+06 | 1.8E+07 |
| 10 | 1000 | 3.8E−08 | 2.6E+10 | 2.6E+11 |

Geometric Mean = 2.2E+09

TABLE 2
Test results with test pipe 1b “fine”
mesh liner at 50% relative humidity (RH)
50% RH/21° C. - test pipe 1b “fine” mesh liner

| | | | Calculated | Surface |
|---|---|---|---|---|
| | | Current | Resistance | Resistivity |
| Test | Voltage | (A) | (Ω) | (Ω/sq) |
| 1 | 1000 | 8.0E−06 | 1.3E+08 | 1.3E+09 |
| 2 | 1000 | 2.5E−06 | 4.0E+08 | 4.0E+09 |
| 3 | 1000 | 6.3E−06 | 1.6E+08 | 1.6E+09 |
| 4 | 1000 | 4.0E−04 | 2.5E+06 | 2.5E+07 |
| 5 | 1000 | 1.5E−05 | 6.7E+07 | 6.7E+08 |
| 6 | 1000 | 6.0E−04 | 1.7E+06 | 1.7E+07 |
| 7 | 1000 | 7.0E−05 | 1.4E+07 | 1.4E+08 |
| 8 | 1000 | 7.0E−06 | 1.4E+08 | 1.4E+09 |
| 9 | 1000 | 1.0E−05 | 1.0E+08 | 1.0E+09 |
| 10 | 1000 | 8.0E−05 | 1.3E+07 | 1.3E+08 |

Geometric Mean = 3.8E+08
Pre-test check @ 25% RH/21° C.

| Voltage(V) | Current (A) | Resistance(Ω) |
|---|---|---|
| 10 | 3.0E−10 | 3.3E+10 |

TABLE 3
Test results with test pipe 1a “coarse” mesh
liner at 25% relative humidity (RH)
25% RH/21° C. - test pipe 1a “coarse” mesh liner

| | | | Calculated | Surface |
|---|---|---|---|---|
| | | Current | Resistance | Resistivity |
| Test | Voltage | (A) | (Ω) | (Ω/sq) |
| 1 | 1000 | 6.0E−04 | 1.7E+06 | 1.7E+07 |
| 2 | 1000 | 3.5E−07 | 2.9E+09 | 2.9E+10 |
| 3 | 1000 | 5.5E−04 | 1.8E+06 | 1.8E+07 |
| 4 | 1000 | 4.0E−04 | 2.5E+06 | 2.5E+07 |
| 5 | 1000 | 1.0E−09 | 1.0E+12 | 1.0E+13 |
| 6 | 1000 | 1.5E−07 | 6.7E+09 | 6.7E+10 |
| 7 | 1000 | 7.0E−08 | 1.4E+10 | 1.4E+11 |
| 8 | 1000 | 6.0E−04 | 1.7E+06 | 1.7E+07 |
| 9 | 1000 | 1.3E−06 | 7.7E+08 | 7.7E+09 |
| 10 | 1000 | 3.5E−07 | 2.9E+09 | 2.9E+10 |

Geometric Mean = 3.1E+09

TABLE 4
Test results with test pipe 1b “fine” mesh
liner at 25% relative humidity (RH)
25% RH/21° C. - test pipe 1a“fine” mesh liner

| | | | Calculated | Surface |
|---|---|---|---|---|
| | | Current | Resistance | Resistivity |
| Test | Voltage | (A) | (Ω) | (Ω/sq) |
| 1 | 1000 | 6.0E−04 | 1.5E+06 | 1.5E+07 |
| 2 | 1000 | 2.5E−07 | 4.0E+07 | 4.0E+08 |
| 3 | 1000 | 3.0E−07 | 3.3E+09 | 3.3E+10 |
| 4 | 1000 | 6.0E−04 | 1.7E+06 | 1.7E+07 |
| 5 | 1000 | 3.0E−06 | 3.3E+08 | 3.3E+09 |
| 6 | 1000 | 1.8E−06 | 5.6E+08 | 5.6E+09 |
| 7 | 1000 | 2.8E−06 | 3.6E+08 | 3.6E+09 |
| 8 | 1000 | 6.0E−04 | 1.7E+06 | 1.7E+07 |
| 9 | 1000 | 7.0E−07 | 1.4E+09 | 1.4E+10 |
| 10 | 1000 | 4.0E−07 | 2.5E+09 | 2.5E+10 |

Geometric Mean = 1.0E+09

All measurements were made on resin layer on the inner surface of pipe.

### Summary of Test Results

The results of the testing completed on test pipe are summarised in Table 5.

TABLE 5
Summary of results

| | |
|---|---|
| Parameter | |
| Surface Resistivity | Test Results (Ω/sq) |

| (Ω/sq) - Geometric Mean | 50% RH/21° C. | 25% RH/21° C. |
|---|---|---|
| “Course” mesh liner | 2.2E+09 | 3.1E+09 |
| “Fine” mesh liner | 3.8E+08 | 1.0E+09 |

Across both sections of the pipe tested, there was a wide range of resistivity readings noted.

This is believed to be down the variability of the resin thickness in proximity to the metallic gauze layer contained within but this was not confirmed. The geometric mean values of the surface resistivity measurements indicate that the inner pipe resin deposit is considered to be dissipative as they fall within the range of 10⁵ Ω/sq to 10¹² Ω/sq as per Table 1 of IEC 60079-32-1: 2013.

### EXAMPLE SET 2

The test pipe preparation and experimental procedures described above were repeated for the following alternative test pipe sections. In the method of preparation, the copper powder was combined with the binder material before the binder material was applied to the fibreglass liner (matting) or the copper mesh (matting).

Test pipe 2a was provided with a simulated repair using the binder material mixed with copper powder and a fibreglass pipe liner (fibreglass matting). The binder material was formed from 200 ml of an epoxy resin part A, 400 ml of an epoxy resin part B and 556 g of copper powder.

Test pipe 2b was provided with a simulated repair using the binder material mixed with copper powder and a fibreglass pipe liner (fibreglass matting). The binder material was formed from 200 ml of an epoxy resin part A, 400 ml of an epoxy resin part B and 1112 g of copper powder.

Test pipe 2c was provided with a simulated repair using the binder material mixed with copper powder and a “fine” copper mesh (copper matting). The binder material was formed from 200 ml of an epoxy resin part A, 400 ml of an epoxy resin part B and 1112 g of copper powder.

Test pipe 2d was provided with a simulated repair using the binder material mixed with copper powder and a “fine” copper mesh (copper matting). The binder material was formed from 200 ml of an epoxy resin part A, 400 ml of an epoxy resin part B and 556 g of copper powder.

Test pipe 2e was provided with a simulated repair using the binder material mixed with a pipe liner formed by needling/interweaving a “fine” copper mesh (copper matting) into a fibreglass pipe liner such that the copper mesh is exposed to the inside of the test section of pipe.

Comparative test pipe 2f was provided by an unrepaired section Thermachem vitrified clay pipe, therefore having no binder material, matting or mesh on the inside surface.

TABLE 6
Test results for test pipe 2a: fibreglass
matting, 556 g copper powder

| | | | | |
|---|---|---|---|---|
| Test | Voltage | Current | Resistance | Surface Resistivity |
| # | (V) | (A) | (Ω) | (Ω/sq) |

Relative humidity = 50%

| | | | | |
|---|---|---|---|---|
| 1 | 1000 | 1.2E−05 | 8.3E+07 | 8.3E+08 |
| 2 | 1000 | 1.0E−04 | 1.0E+07 | 1.0E+08 |
| 3 | 1000 | 7.5E−06 | 1.3E+08 | 1.3E+09 |
| 4 | 1000 | 4.5E−06 | 2.2E+08 | 2.2E+09 |
| 5 | 1000 | 1.2E−05 | 8.3E+07 | 8.3E+08 |
| 6 | 1000 | 7.5E−06 | 1.3E+08 | 1.3E+09 |
| 7 | 1000 | 4.5E−05 | 2.2E+07 | 2.2E+08 |
| 8 | 1000 | 4.5E−05 | 2.2E+07 | 2.2E+08 |
| 9 | 1000 | 2.5E−05 | 4.0E+07 | 4.0E+08 |
| 10 | 1000 | 4.5E−06 | 2.2E+08 | 2.2E+08 |

Geometric Mean = 5.1E+08
Relative humidity = 25%

| | | | | |
|---|---|---|---|---|
| 1 | 1000 | 9.2E−06 | 1.1E+08 | 1.1E+09 |
| 2 | 1000 | 1.6E−05 | 6.3E+07 | 6.3E+08 |
| 3 | 1000 | 1.2E−05 | 8.3E+07 | 8.3E+08 |
| 4 | 1000 | 1.0E−05 | 1.0E+08 | 1.0E+09 |
| 5 | 1000 | 4.5E−06 | 2.2E+08 | 2.2E+09 |
| 6 | 1000 | 4.5E−06 | 2.2E+08 | 2.2E+09 |
| 7 | 1000 | 7.4E−06 | 1.3E+08 | 1.3E+09 |
| 8 | 1000 | 2.5E−05 | 4.0E+07 | 4.0E+08 |
| 9 | 1000 | 5.3E−06 | 1.9E+08 | 1.9E+09 |
| 10 | 1000 | 5.0E−06 | 2.0E+08 | 2.0E+09 |

Geometric Mean = 1.2E+09

TABLE 7
Test results for test pipe 2b: fibreglass
matting, 1112 g copper powder

| | | | | |
|---|---|---|---|---|
| Test | Voltage | Current | Resistance | Surface Resistivity |
| # | (V) | (A) | (Ω) | (Ω/sq) |

Relative humidity = 50%

| | | | | |
|---|---|---|---|---|
| 1 | 1000 | 2.6E−05 | 4.0E+07 | 4.0E+08 |
| 2 | 1000 | 6.0E−04 | 1.7E+06 | 1.7E+07 |
| 3 | 1000 | 6.0E−04 | 1.7E+06 | 1.7E+07 |
| 4 | 1000 | 5.9E−04 | 1.7E+06 | 1.7E+07 |
| 5 | 1000 | 6.0E−04 | 1.7E+06 | 1.7E+07 |
| 6 | 1000 | 6.0E−04 | 1.7E+06 | 1.7E+07 |
| 7 | 1000 | 5.0E−05 | 2.0E+07 | 2.0E+08 |
| 8 | 1000 | 5.9E−04 | 1.7E+06 | 1.7E+07 |
| 9 | 1000 | 1.1E−04 | 9.1E+06 | 9.1E+07 |
| 10 | 1000 | 8.0E−05 | 1.3E+07 | 1.3E+08 |

Geometric Mean = 4.3E+07
Relative humidity = 25%

| | | | | |
|---|---|---|---|---|
| 1 | 1000 | 2.3E−05 | 4.3E+07 | 4.3E+08 |
| 2 | 1000 | 5.3E−04 | 1.9E+06 | 1.9E+07 |
| 3 | 1000 | 5.7E−04 | 1.8E+06 | 1.8E+07 |
| 4 | 1000 | 2.5E−05 | 4.0E+07 | 4.0E+08 |
| 5 | 1000 | 3.7E−05 | 2.7E+07 | 2.7E+08 |
| 6 | 1000 | 1.4E−05 | 7.1E+07 | 7.1E+08 |
| 7 | 1000 | 4.4E−05 | 2.3E+07 | 2.3E+08 |
| 8 | 1000 | 5.7E−04 | 1.8E+06 | 1.8E+07 |
| 9 | 1000 | 5.8E−04 | 1.7E+06 | 1.7E+07 |
| 10 | 1000 | 4.5E−04 | 2.2E+06 | 2.2E+07 |

Geometric Mean = 8.4E+07

TABLE 8
Test results for test pipe 2c: copper matting, 1112 g copper powder

| | | | | |
|---|---|---|---|---|
| Test | Voltage | Current | Resistance | Surface Resistivity |
| # | (V) | (A) | (Ω) | (Ω/sq) |

Relative humidity = 50%

| | | | | |
|---|---|---|---|---|
| 1 | 1000 | 5.8E−04 | 1.7E+06 | 1.7E+07 |
| 2 | 1000 | 6.0E−04 | 1.7E+06 | 1.7E+07 |
| 3 | 1000 | 5.8E−04 | 1.7E+06 | 1.7E+07 |
| 4 | 1000 | 8.0E−04 | 1.3E+06 | 1.3E+07 |
| 5 | 1000 | 6.5E−04 | 1.5E+06 | 1.5E+07 |
| 6 | 1000 | 8.0E−04 | 1.3E+06 | 1.3E+07 |
| 7 | 1000 | 7.3E−04 | 1.4E+06 | 1.4E+07 |
| 8 | 1000 | 6.8E−04 | 1.5E+06 | 1.5E+07 |
| 9 | 1000 | 7.3E−04 | 1.4E+06 | 1.4E+07 |
| 10 | 1000 | 9.0E−04 | 1.1E+06 | 1.1E+07 |

Geometric Mean = 1.5E+07
Relative humidity = 25%

| | | | | |
|---|---|---|---|---|
| 1 | 1000 | 6.0E−06 | 1.7E+08 | 1.7E+09 |
| 2 | 1000 | 4.3E−05 | 2.3E+07 | 2.3E+08 |
| 3 | 1000 | 6.0E−04 | 1.7E+06 | 1.7E+07 |
| 4 | 1000 | 5.5E−04 | 1.8E+06 | 1.8E+07 |
| 5 | 1000 | 5.0E−04 | 2.0E+06 | 2.0E+07 |
| 6 | 1000 | 5.8E−04 | 1.7E+06 | 1.7E+07 |
| 7 | 1000 | 5.3E−04 | 1.9E+06 | 1.9E+07 |
| 8 | 1000 | 4.1E−04 | 2.4E+06 | 2.4E+07 |
| 9 | 1000 | 5.5E−04 | 1.8E+06 | 1.8E+07 |
| 10 | 1000 | 6.0E−04 | 1.7E+06 | 1.7E+07 |

Geometric Mean = 3.8E+07

TABLE 9
Test results for test pipe 2d: copper matting, 556 g copper powder

| | | | | |
|---|---|---|---|---|
| Test | Voltage | Current | Resistance | Surface Resistivity |
| # | (V) | (A) | (Ω) | (Ω/sq) |

Relative humidity = 50%

| | | | | |
|---|---|---|---|---|
| 1 | 1000 | 6.0E−04 | 1.7E+06 | 1.7E+07 |
| 2 | 1000 | 5.7E−04 | 1.8E+06 | 1.8E+07 |
| 3 | 1000 | 8.5E−04 | 1.2E+06 | 1.2E+07 |
| 4 | 1000 | 5.8E−04 | 1.7E+06 | 1.7E+07 |
| 5 | 1000 | 1.7E−07 | 5.9E+09 | 5.9E+10 |
| 6 | 1000 | 6.0E−04 | 1.7E+06 | 1.7E+07 |
| 7 | 1000 | 5.7E−04 | 1.8E+06 | 1.8E+07 |
| 8 | 1000 | 7.5E−04 | 1.3E+06 | 1.3E+07 |
| 9 | 1000 | 5.6E−04 | 1.8E+06 | 1.8E+07 |
| 10 | 1000 | 6.0E−04 | 1.7E+06 | 1.7E+07 |

Geometric Mean = 3.7E+07
Relative humidity = 25%

| | | | | |
|---|---|---|---|---|
| 1 | 1000 | 6.0E−04 | 1.7E+06 | 1.7E+07 |
| 2 | 1000 | 7.0E−04 | 1.4E+06 | 1.4E+07 |
| 3 | 1000 | 5.7E−04 | 1.8E+06 | 1.8E+07 |
| 4 | 1000 | 3.7E−05 | 2.7E+07 | 2.7E+08 |
| 5 | 1000 | 6.2E−04 | 1.6E+06 | 1.6E+07 |
| 6 | 1000 | 5.8E−04 | 1.7E+06 | 1.7E+07 |
| 7 | 1000 | 5.3E−04 | 1.9E+06 | 1.9E+07 |
| 8 | 1000 | 6.0E−04 | 1.7E+06 | 1.7E+07 |
| 9 | 1000 | 6.0E−04 | 1.7E+06 | 1.7E+07 |
| 10 | 1000 | 6.0E−04 | 1.7E+06 | 1.7E+07 |

Geometric Mean = 2.2E+07

TABLE 10
Test results for test pipe 2e: pipe liner formed by needling/interweaving
a “fine” copper mesh (copper matting) into a
fibreglass pipe liner

| | | | | |
|---|---|---|---|---|
| Test | Voltage | Current | Resistance | Surface Resistivity |
| # | (V) | (A) | (Ω) | (Ω/sq) |

Relative humidity = 50%

| | | | | |
|---|---|---|---|---|
| 1 | 500 | 5.8E−04 | 8.6E+05 | 8.6E+06 |
| 2 | 500 | 1.5E−05 | 3.3E+02 | 3.3E+08 |
| 3* | 500 | 2.3E−13 | 6.8E+14 | 6.8E+15 |
| 4 | 500 | 6.5E−04 | 7.7E+05 | 7.7E+06 |
| 5 | 500 | 5.8E−04 | 8.6E+05 | 8.6E+06 |
| 6 | 500 | 5.8E−04 | 8.6E+05 | 8.6E+06 |
| 7 | 500 | 2.5E−04 | 2.0E+06 | 2.0E+08 |
| 8* | 500 | 5.5E−12 | 9.1E+13 | 9.1E+14 |
| 9* | 500 | 1.0E−11 | 5.0E+13 | 5.0E+14 |
| 10* | 500 | 1.0E−11 | 5.0E+13 | 5.0E+14 |

Geometric Mean = 2.3E+10
Relative humidity = 25%

| | | | | |
|---|---|---|---|---|
| 1 | 500 | 5.8E−04 | 8.6E+05 | 8.6E+06 |
| 2 | 500 | 6.0E−12 | 8.3E+13 | 8.3E+14 |
| 3 | 500 | 3.5E−12 | 1.4E+14 | 1.4E+15 |
| 4 | 500 | 6.0E−04 | 8.3E+05 | 8.3E+06 |
| 5 | 500 | 4.0E−10 | 1.3E+12 | 1.3E+13 |
| 6 | 500 | 2.5E−10 | 2.0E+12 | 2.0E+13 |
| 7 | 500 | 2.0E−03 | 2.5E+07 | 2.5E+08 |
| 8 | 500 | 2.5E−11 | 2.0E+13 | 2.0E+14 |
| 9 | 500 | 1.0E−11 | 5.0E+13 | 5.0E+14 |
| 10 | 500 | 1.5E−11 | 3.3E+13 | 3.3E+14 |

Geometric Mean = 1.7E+12

TABLE 10
Test results for comparative test pipe
2f: no simulated repaired section

| | | | | |
|---|---|---|---|---|
| Test | Voltage | Current | Resistance | Surface Resistivity |
| # | (V) | (A) | (Ω) | (Ω/sq) |

Relative humidity = 50%

| | | | | |
|---|---|---|---|---|
| 1 | 1000 | 2.3E−07 | 4.3E+09 | 4.3E+10 |
| 2 | 1000 | 1.4E−07 | 7.1E+09 | 7.1E+10 |
| 3 | 1000 | 2.0E−07 | 5.0E+09 | 5.0E+10 |
| 4 | 1000 | 3.1E−07 | 3.2E+09 | 3.2E+10 |
| 5 | 1000 | 1.4E−07 | 7.1E+09 | 7.1E+10 |
| 6 | 1000 | 2.1E−07 | 4.8E+09 | 4.8E+10 |
| 7 | 1000 | 3.8E−07 | 2.6E+09 | 2.6E+10 |
| 8 | 1000 | 3.5E−08 | 2.9E+10 | 2.9E+10 |
| 9 | 1000 | 1.6E−08 | 6.3E+10 | 6.3E+10 |
| 10 | 1000 | 4.5E−08 | 2.2E+10 | 2.2E+10 |

Geometric Mean = 4.2E+10
Relative humidity = 25%

| | | | | |
|---|---|---|---|---|
| 1 | 1000 | 1.5E−09 | 6.7E+11 | 6.7E+12 |
| 2 | 1000 | 5.5E−09 | 1.8E+11 | 1.8E+12 |
| 3 | 1000 | 5.0E−09 | 2.0E+11 | 2.0E+12 |
| 4 | 1000 | 1.3E−08 | 7.7E+10 | 7.7E+11 |
| 5 | 1000 | 3.0E−09 | 3.3E+11 | 3.3E+12 |
| 6 | 1000 | 2.3E−09 | 4.3E+11 | 4.3E+12 |
| 7 | 1000 | 1.0E−09 | 1.0E+12 | 1.0E+13 |
| 8 | 1000 | 3.7E−09 | 2.7E+11 | 2.7E+12 |
| 9 | 1000 | 3.0E−09 | 3.3E+11 | 3.3E+12 |
| 10 | 1000 | 3.5E−09 | 2.9E+11 | 2.9E+12 |

Geometric Mean = 3.0E+12

These results show that a repaired section of a pipe has a surface electrical resistivity which classifies it as dissipative, after a method of the first aspect has been carried out. Specifically the results above show that a test section of pipe having a simulated repair section formed from either a binder material with a copper mesh (Tables 1-5), a binder material comprising copper powder with a fibreglass pipe liner (Tables 6 and 7), a binder material comprising a copper powder with a copper mesh (Tables 8 and 9) or a binder material with a copper mesh interwoven with a fibreglass pipe liner (Table 10) all provide a simulated repaired section of pipe which is dissipative. Such test sections of pipe show comparable or improved dissipative properties compared to an unrepaired section of the same pipe (Table 11).

This means that such a repaired section, when used on a damaged pipe of the type discussed above, would have a sufficient conductivity in the repaired part to reduce, suitably prevent, static charge build-up across the repaired part of the pipe and therefore reduce the risk of a spark produced by a static electrical discharge across the binder material causing a flammable liquid within the pipe to ignite. The results therefore show that the method of the first aspect may provide a safer pipe repair, particularly wherein the pipe is normally used for transporting flammable liquids, and may therefore protect the pipework, associated plant and pipe/plant operators from damage or injury caused by sparks produced by static electrical discharge.

In summary, the present invention provides a method of repairing a pipe and/or a drain. The method involves covering a damaged section of pipe with a binder material and a conductive/dissipative material. The conductive/dissipative material is arranged in contact with, suitably within, the binder material and functions to reduce static electrical charge build-up across the binder material, compared to the static charge build-up that may otherwise occur in a comparable section of binder material not having the conductive/dissipative material. The method may reduce the risk of a spark produced by a static electrical discharge across the binder material causing a flammable liquid within the pipe to ignite. The method of this first aspect may therefore provide a safer pipe repair, particularly wherein the pipe is normally used for transporting flammable liquids. A kit, composition, pipe and uses of a kit or composition to repair a pipe are also provided.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding addition of other components.

Whenever appropriate, depending upon the context, the use of the term “comprises” or “comprising” may also be taken to encompass or include the meaning “consists essentially of” or “consisting essentially of”, and may also be taken to include the meaning “consists of” or “consisting of”.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A method of repairing a pipe, the method comprising applying, to an internal surface of the pipe at a location of the pipe to be repaired, a binder material and a conductive/dissipative material for reducing static electrical charge build-up across the binder material.

2. The method according to claim 1, wherein the conductive/dissipative material is formed from a conductive material.

3. The method according to claim 1, wherein the binder material and the conductive/dissipative material are applied to the internal surface of the pipe together.

4. The method according to claim 1, wherein the method comprises the steps of:
a) applying the binder material to the internal surface of the pipe at the location of the pipe to be repaired; and
b) applying the conductive/dissipative material to the internal surface of the pipe at the location of the pipe to be repaired, in contact with the binder material and substantially traversing the binder material.

5. The method according to claim 1, wherein the binder material covers a cylindrical section of the pipe.

6. The method according to claim 1, wherein the conductive/dissipative material is in the form of conductive/dissipative particles.

7. The method according to claim 1, wherein the conductive/dissipative material is in the form of at least one elongate element.

8. The method according to claim 7, wherein the conductive/dissipative material is in the form of a plurality of elongate elements.

9. The method according to claim 8, wherein the elongate elements are provided as a tubular mesh.

10. The method according to claim 1, wherein the conductive/dissipative material comprises copper.

11. (canceled)

12. A composition for repairing a pipe, the composition comprising:
a binder material; and
a conductive/dissipative material for reducing static charge build-up across the binder material.

13. A pipe comprising at least one section comprising a binder material and a conductive/dissipative material for reducing static charge build-up across the binder material.

14. (canceled)

15. (canceled)

16. The composition of claim 12, wherein the conductive/dissipative material is formed from a conductive material.

17. The composition of claim 12, wherein the conductive/dissipative material is in the form of conductive/dissipative particles.

18. The composition of claim 12, wherein the conductive/dissipative material is in the form of at least one elongate element.

19. The composition of claim 18, wherein the conductive/dissipative material is in the form of a plurality of elongate elements.

20. The composition of claim 19, wherein the elongate elements are provided as a tubular mesh.

21. The composition of claim 12, wherein the conductive/dissipative material comprises copper.
